(19) United States
(12) Patent Application Publication
(10) Pub. No.: US 2021/0287457 A1
(43) Pub. Date: Sep. 16, 2021

(54) COMMUNICATION CONTROL SYSTEM

(71) Applicant: Honda Motor Co., Ltd., Tokyo (JP)

(72) Inventors: Satoshi Furuhashi, Wako-shi (JP); Nobuaki Takeo, Wako-shi (JP); Shuji Tomimatsu, Wako-shi (JP); Tatsuro Saito, Wako-shi (JP)

(21) Appl. No.: 17/190,516

(22) Filed: Mar. 3, 2021

(30) Foreign Application Priority Data
Mar. 10, 2020 (JP) 2020-040736

(51) Int. Cl. G07C 5/08; G07C 5/00; H04W 4/48

(52) U.S. Cl. CPC G07C 5/0808; H04W 4/48; G07C 5/0816; G07C 5/008

(57) ABSTRACT

A communication control system includes: first/second control unit configured to control vehicle; first relay unit communicatively connected to the first control unit and having input unit to which data signal from diagnostic unit diagnosing state of the vehicle is input; second relay unit communicatively connected to the second control unit; first communication line communicatively connecting the first relay unit and the second relay unit; and second communication line disposed in parallel to the first communication line and communicatively connecting the first/second relay units. The data signal input to the first relay unit includes identification information. The first relay unit controls flow of data so that the data signal input to the first relay unit is transmitted through the second communication line when the data signal input to the first relay unit includes the identification information set to be communicated through the second communication line.

### CROSS-REFERENCE TO RELATED APPLICATION

This application is based upon and claims the benefit of priority from Japanese Patent Application No. 2020-040736 filed on Mar. 10, 2020, the content of which is incorporated herein by reference.

### BACKGROUND OF THE INVENTION

### Field of the Invention

This invention relates to a communication control system for controlling communication in an in-vehicle network.

### Description of the Related Art

There has been known a system configured such that a diagnostic device diagnosing a state of a vehicle is connectable to an in-vehicle network (see, for example, JP 2014-165641 A). In the system disclosed in JP 2014-165641 A, the diagnostic device is connected to the in-vehicle network via a data link connector connected to a gateway.

However, as in the system disclosed in JP 2014-165641 A, if the gateway to which the diagnostic device is connected and an electronic control unit diagnosed by the diagnostic device communicate through a communication line identical to another electronic control unit, a traffic on the communication line may become excessive, which may cause a communication delay between the diagnostic device and the electronic control unit.

### SUMMARY OF THE INVENTION

An aspect of the present invention is a communication control system, including: a first control unit configured to control a vehicle; a second control unit configured to control the vehicle; a first relay unit communicatively connected to the first control unit and having an input unit to which a data signal from a diagnostic unit diagnosing state of the vehicle is input; a second relay unit communicatively connected to the second control unit; a first communication line communicatively connecting the first relay unit and the second relay unit; and a second communication line disposed in parallel to the first communication line and communicatively connecting the first relay unit and the second relay unit. The data signal input to the first relay unit includes identification information. The first relay unit controls flow of data so that the data signal input to the first relay unit is transmitted through the second communication line when the data signal input to the first relay unit includes the identification information set to be communicated through the second communication line.

### BRIEF DESCRIPTION OF THE DRAWINGS

The objects, features, and advantages of the present invention will become clearer from the following description of embodiments in relation to the attached drawings, in which:

FIG. 1 is a diagram schematically showing an example of configuration of an in-vehicle network functioning as a communication control system according to an embodiment of the present invention;

FIG. 2 is a diagram for explaining data frames input to a function integration module and an integrated management gateway in FIG. 1;

FIG. 3 is a block diagram schematically showing main configuration of parts configuring the in-vehicle network according to the embodiment of the present invention;

FIG. 4 is a flowchart showing an example of processing performed by the integrated management gateway configuring the communication control system according to the embodiment of the present invention; and

FIG. 5 is a flowchart showing an example of processing performed by the function integration module configuring the communication control system according to the embodiment of the present invention.

### DETAILED DESCRIPTION OF THE INVENTION

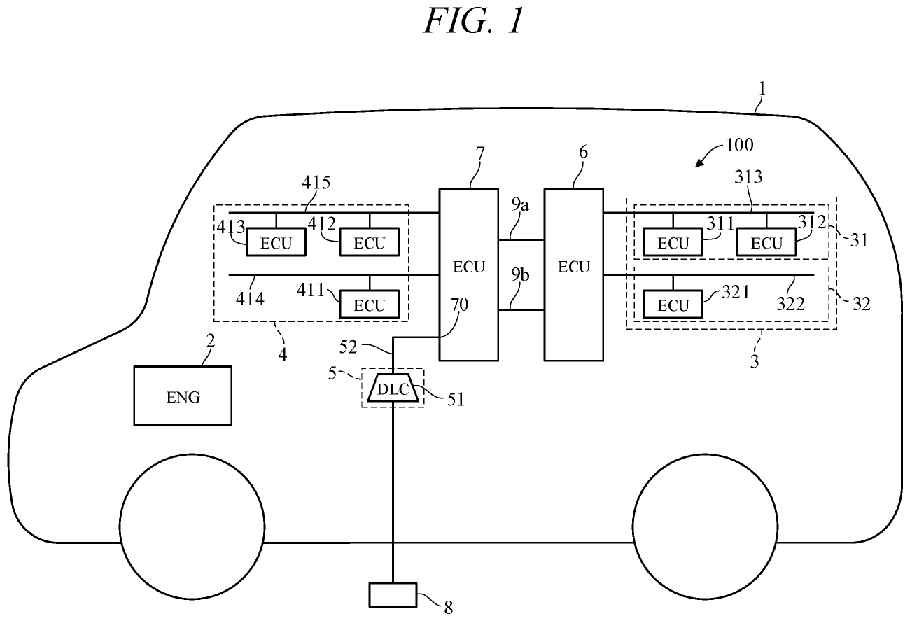

An embodiment of the present invention will be described below with reference to FIGS. 1 to 5. FIG. 1 is a schematic diagram of an example of an in-vehicle network 100 functioning as a communication control system according to the embodiment of the present invention. As shown in FIG. 1, a vehicle 1 having the in-vehicle network 100 is equipped with an engine (ENG) 2. A driving source of the vehicle 1 is not limited to the engine 2, but may include the engine 2 and a motor (electric motor).

The in-vehicle network 100 includes a control system network 3, an information system network 4, an external connection network 5, a function integration module (ECU) 6 integrally controlling the control system network 3, and an integrated management gateway (ECU) 7 integrally managing the networks 3, 4, and 5. The integrated management gateway 7 configures a first repeater, and the function integration module 6 configures a second repeater.

The control system network 3 has a power train system network 31 related to a power train of the vehicle 1 and a chassis system network 32 related to a chassis. The control system network 3 includes a safety system network related to safety of the vehicle 1, a vehicle body system network related to a vehicle body, and the like (not shown).

The power train system network 31 has a plurality of ECUs (second control units) performing control related to the power train of the vehicle 1, such as an engine control ECU (ECU) 311 controlling the engine 2 and a transmission control ECU (ECU) 312 controlling a transmission (not shown). The chassis system network 32 has the plurality of ECUs (second control units) performing control related to a mechanism of the vehicle body of the vehicle 1 such as a steering control ECU (ECU) 321 controlling a steering device (not shown).

Each of the ECUs 311, 312, and 321 configuring the control system network 3 includes a computer having a CPU, a RAM, a ROM, and other peripheral circuits. Each of the ECUs 311, 312, and 321 executes various control on the basis of signals from various sensors (not shown), other ECUs, and a diagnostic device 8 in accordance with a program stored in a memory in advance.

The ECUs 311, 312, and 321 of the control system network 3 are communicably connected to each other for each function via serial communication lines 313 and 322 such as a controller area network (CAN) communication line. For example, the engine control ECU 311 and the transmission control ECU 312 are communicably connected to each other via the serial communication line 313, and the steering control ECU 321 is communicably connected to the other ECUs of the chassis system network 32 via the serial communication line 322.

The serial communication lines 313 and 322 connecting the ECUs 311, 312, and 321 of the control system network 3 are connected to the function integration module 6, and the power train system network 31 and the chassis system network 32 are communicably connected to each other via the serial communication lines 313 and 322.

The function integration module 6 integrally controls ECUs that directly affect operations of the vehicle 1 (running, steering, stopping, and the like), that is, the ECUs 311, 312, and 321 of the control system network 3, and relays (transfers) data signals transmitted and received between the serial communication lines 313 and 322. The function integration module 6 is communicably connected to each other via the integrated management gateway 7 and a first serial communication line (first communication line) 9a, and relays (transfers) the data signals transmitted from the ECUs 311, 312, and 321 of the control system network 3 to the integrated management gateway.

The control system network 3, which has the plurality of ECUs 311, 312, and 321 that directly affects the operations of the vehicle 1, is required to be highly reliable and safe. That is, the control system network 3 has a relatively high security level. Therefore, the control system network 3 is not directly connected to the integrated management gateway 7 to which the external connection network 5 is connected, but is connected to the integrated management gateway 7 via the function integration module 6.

The information system network 4 has a plurality of ECUs (first control units) performing control related to information on the vehicle 1 such as a meter control ECU 411 controlling a meter displaying an operating state of the vehicle 1 such as a vehicle speed and a shift position, an air conditioner control ECU 412 controlling an air conditioner, and a navigation control ECU 413 controlling a navigation device. Although not shown, the information system network includes a telematics control unit controlling bidirectional communication between the vehicle 1 and a predetermined server device.

Each of the ECU 411, 412, and 413 configuring the information system network 4 includes a computer having a CPU, a RAM, a ROM, and other peripheral circuits, and executes various control on the basis of signals from various sensors (not shown), other ECUs, and the diagnostic device 8 in accordance with a program stored in the memory in advance.

The ECUs 411, 412, and 413 of the information system network 4 are communicably connected to each other via serial communication lines 414 and 415 such as a CAN communication line. The serial communication lines 414 and 415 connecting the ECUs 411, 412, and 413 are connected to the integrated management gateway 7.

The information system network 4 does not have an ECU that directly affects the operations of the vehicle 1, and thus the information system network 4 can be configured to have a relatively low security level and can be directly connected to the integrated management gateway 7 to which the external connection network 5 is connected.

The external connection network 5 has a data link connector (DLC) 51 capable of connecting an external device such as the diagnostic device 8. The data link connector 51 is a connection device for wire-connecting an external device such as the diagnostic device 8, and is connected to the input unit 70 of the integrated management gateway 7 via a serial communication line (external serial communication line) 52 such as a CAN communication line. The diagnostic device 8 connected to the integrated management gateway 7 via the data link connector 51 is communicable with the integrated management gateway 7 via the serial communication line 52. The data link connector 51 may be wirelessly communicably connected (wirelessly connected) to the input unit 70 of the integrated management gateway 7.

The integrated management gateway 7 relays (transfers) data signals transmitted and received between the plurality of ECUs that does not directly affect the operations of the vehicle 1, that is, the serial communication lines 414 and 415 connecting the ECUs 411, 412, and 413 of the information system network 4. The integrated management gateway 7 relays (transfers) data signals transmitted and received to and from the diagnostic device 8 via the serial communication line 52 and data signals transmitted and received to and from the function integration module 6 via the first serial communication line 9a.

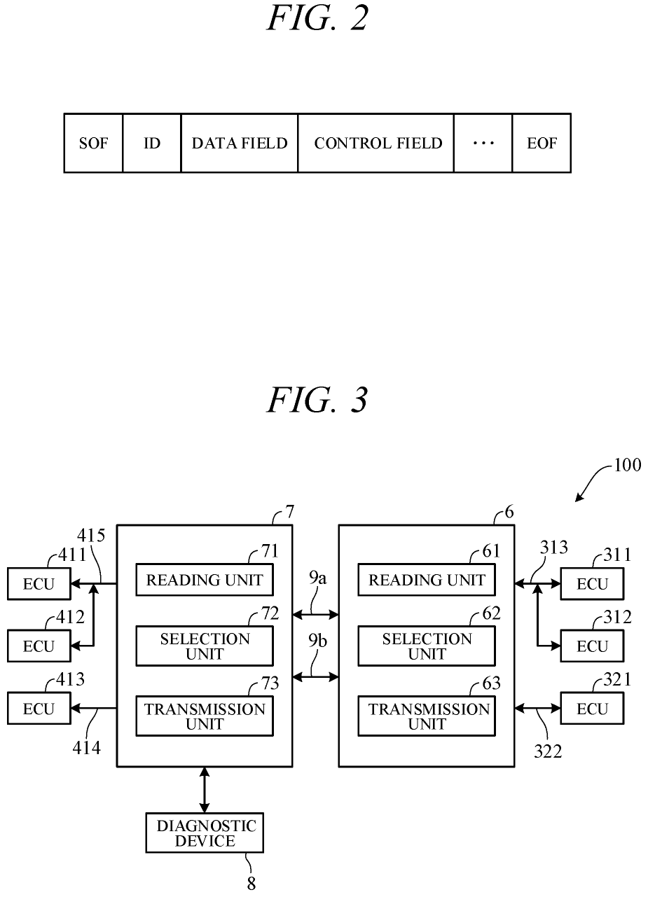

FIG. 2 is a diagram for explaining data frames of data signals input to the function integration module 6 and the integrated management gateway 7. The data signal obtained by calculation processing in the ECUs and a diagnostic signal input from the diagnostic device 8 are input to the function integration module 6 and the integrated management gateway 7 as one data frame.

As shown in FIG. 2, the data frames include a start of frame (SOF) indicating a start of a data frame, an ID indicating identification information such as a transmission source, a transmission destination, and a type of data, a data field as substantial data, a control field indicating a length of the data field, and an end of frame (EOF) indicating an end of the data frame. The identification information of the ID includes types of signals such as a data signal or a diagnostic signal. Each field includes, for example, a pulse signal having an SOF of 1 bit, an ID of 11 bits, a data field of 0 to 64 bits, a control field of 6 bits, and an EOF of 7 bits.

The ECUs 311, 312, and 321 of the control system network 3 receive only a data frame including a preset ID to be received on the basis of the ID of each data frame from a data frame input to the serial communication lines 313 and 322 to which the ECUs 311, 312, and 321 are connected. Thus, for example, the transmission control ECU 312 receives an engine speed transmitted from the engine control ECU 311 and uses the engine speed for the processing of the next calculation cycle, and thus the ECUs are cooperatively controlled between the control system networks 3.

Similarly, the ECUs 311, 312, and 321 of the control system network 3 and the ECUs 411, 412, and 413 of the information system network 4 receive only a data frame including a preset ID to be received on the basis of the ID of each data frame from the data frame transmitted and received via the first serial communication line 9a. Thus, for example, the meter control ECU 411 receives the engine speed transmitted from the engine control ECU 311 and the shift position transmitted from the transmission control ECU and controls a display of the meter, and thus the ECUs are cooperatively controlled between the control system network 3 and the information system network 4.

In the in-vehicle network 100 described above, when an ignition switch of the vehicle 1 is turned on, the ECUs 311, 312, and 321 of the control system network 3 and the ECUs 411, 412, and 413 of the information system network 4 transmit and receive various data signals. As a result, when the ignition switch is turned on, numerous data signals flow through the first serial communication line 9a connecting the integrated management gateway 7 and the function integration module 6.

On the other hand, a failure diagnosis of the vehicle 1 using the ECUs of the control system network 3 is performed in a state where the ignition switch of the vehicle 1 is turned on. Thus, numerous data signals are already flowing through the first serial communication line 9a connecting the integrated management gateway 7 and the function integration module 6. If the communication line connecting the integrated management gateway 7 and the function integration module 6 includes only the first serial communication line 9a, the data transmitted and received by the diagnostic device 8 is added to the first serial communication line 9a. This can cause an excessive traffic, which is an amount of data per unit time in the communication line. As a result, a communication delay or the like may occur between the ECUs of the control system network 3 used for diagnosis and the diagnostic device 8. In the present embodiment, the communication control system is configured as follows so as to prevent a communication delay between the ECUs of the control system network 3 used for diagnosis of the vehicle 1 and the diagnostic device 8.

FIG. 3 is a schematic block diagram of a main configuration of parts configuring the in-vehicle network 100 according to the embodiment of the present invention. As shown in FIG. 3, the function integration module 6 and the integrated management gateway 7 are communicably connected to each other via the first serial communication line 9a and a second serial communication line (second communication line) 9b disposed in parallel to the first serial communication line 9a.

Each of the function integration module 6 and the integrated management gateway 7 includes a computer having a CPU, a RAM, a ROM, and other peripheral devices. The function integration module 6 and the integrated management gateway 7 have, as a functional configuration, reading units 61 and 71 reading identification information (ID) included in the data frame of an input data signal, selection units 62 and 72 selecting a communication line on the basis of the IDs read by the reading units 61 and 71, and transmission units 63 and 73 controlling a flow of the data frame such that the data frame is communicated via the communication line selected by the selection units 62 and 72, respectively.

The reading unit 61 reads the IDs of all the data frames input to the serial communication lines 313 and 322 and the first and second serial communication lines 9a and 9b. The selection unit 62 selects the serial communication lines 313, 322, 9a, and 9b inputting the data frames on the basis of the ID read by the reading unit 61. Specifically, the selection unit 62 selects the first serial communication line 9a when the ID having the ECUs 411, 412, and 413 of the information system network 4 as the transmission destination is included, and selects the second serial communication line 9b when the ID having the diagnostic device 8 as the transmission destination is included. When an ID having the ECUs of the control system network 3 as the transmission destination is included, the selection unit 62 selects the serial communication lines 313 and 322 to which the corresponding ECUs are connected.

The transmission unit 63 inputs the data frame to the corresponding communication line such that the data frame is transmitted via the communication line selected by the selection unit 62.

The reading unit 71 reads the IDs of all the data frames input to the serial communication lines 414, 415, and 52 and the first and second serial communication lines 9a and 9b. The selection unit 72 selects, on the basis of the ID read by the reading unit 71, the serial communication lines 414, 415, and 52 and the first and second serial communication lines 9a and 9b to which the data frame is input. Specifically, the selection unit 72 selects the first serial communication line 9a when the ID having the control system network 3 as the transmission destination and the information system network 4 as the transmission source is included, and selects the second serial communication line 9b when the ID having the control system network 3 as the transmission destination and the diagnostic device 8 as the transmission source is included. When the transmission destination is the information system network 4 and the transmission source is the diagnostic device 8, the selection unit 72 selects the serial communication lines 414 and 415 to which the corresponding ECU is connected. The selection unit 72 may select the serial communication lines 414 and 415 to which the corresponding ECUs are connected when the type of the signal is a first diagnostic signal having the information system network 4 as the transmission destination, and the selection unit 72 may select the second serial communication line 9b when the type of the signal is a second diagnostic signal having the control system network 3 as the transmission destination. The transmission unit 73 inputs the data frame to the corresponding communication line such that the data frame is transmitted via the communication line selected by the selection unit 72.

This can prevent occurrence of a communication delay between the diagnostic device 8 and the ECUs 311, 312, and 321 of the control system network 3 during the failure diagnosis of the vehicle 1 using the ECUs 311, 312, and 321 of the control system network 3. For example, when the engine control ECU 311 is used to diagnose a failure of an emission-related device of the vehicle 1, it is possible to prevent a failure of the device from being erroneously determined due to a delay in communication caused by traffic of a communication line.

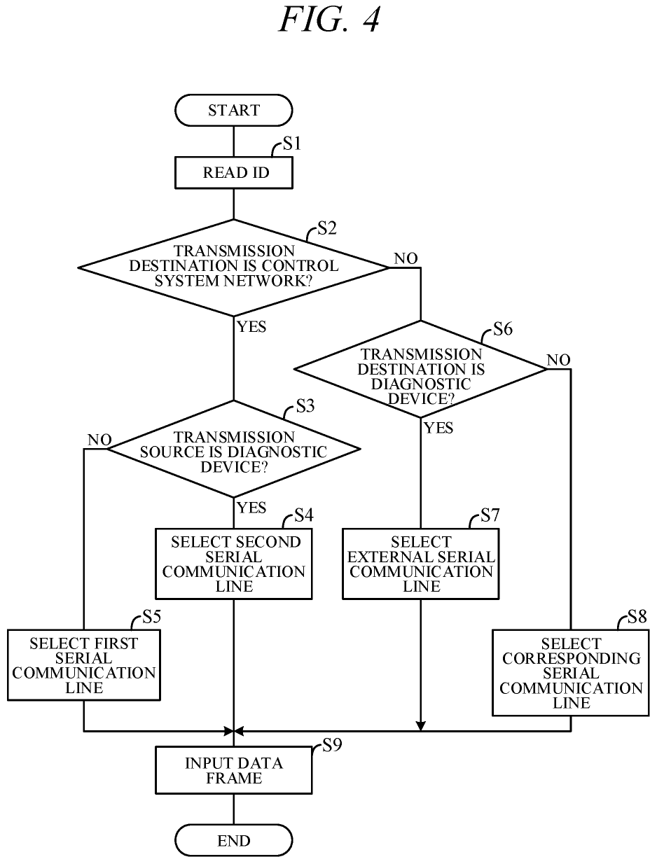

FIG. 4 is a flowchart of an example of processing executed by the integrated management gateway 7 in accordance with a program stored in the memory in advance. The processing shown in the flowchart starts when a data frame is input to a communication line, and is repeated at predetermined time intervals.

First, at S1 (S: processing step), the identification information (ID) of the input data frame is read by the processing of the reading unit 71. Next, at S2, it is determined whether the transmission destination of the data frame in which the ID is read is the control system network 3 by the processing of the selection unit 72. If the determination is affirmative in S2, it is determined in S3 whether the transmission source is the diagnostic device 8. If the determination is affirmative in S3, the second serial communication line 9b is selected in S4. On the other hand, if the determination is negative in S3, the first serial communication line 9a is selected in S5.

If the determination is negative in S2, it is determined in S6 whether the transmission destination is the diagnostic device 8. If the determination is affirmative in S6, the external serial communication line 52 is selected in S7. On the other hand, if the determination is negative in S6, the serial communication line to which the corresponding ECU of the information system network 4 is connected is selected in S8.

Next, in S9, the data frame is input to the corresponding communication line such that the data frame is transmitted through the communication line selected in S4, S5, S7, and S8 by the processing in the transmission unit 73.

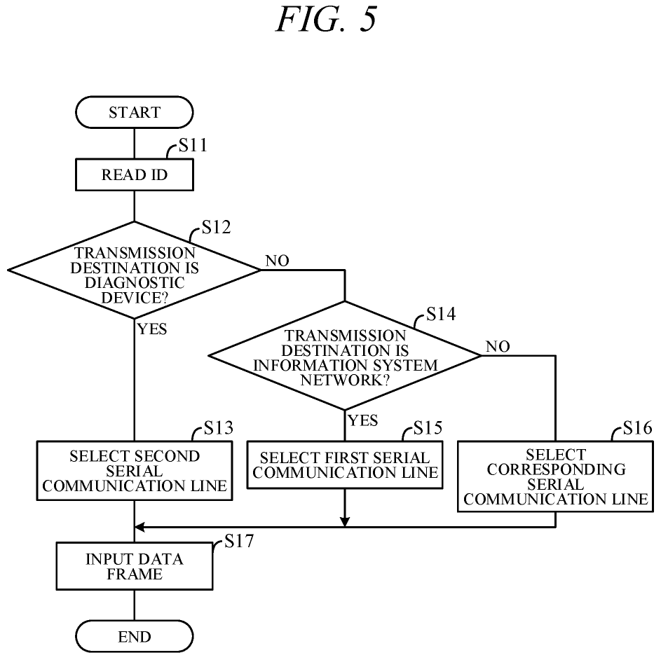

FIG. 5 is a flowchart of an example of processing executed by the function integration module 6 in accordance with a program stored in the memory in advance. The processing shown in the flowchart starts when a data frame is input to a communication line, and is repeated at predetermined time intervals.

First, in S11, the identification information (ID) of the input data frame is read by the processing of the reading unit 61. Next, at S12, it is determined whether the transmission destination of the data frame in which the ID is read is the diagnostic device 8 by the processing of the selection unit 62. If the determination is affirmative in S12, the second serial communication line 9b is selected in S13.

On the other hand, if the determination is negative in S12, it is determined in S14 whether the transmission destination is the information system network. If the determination is affirmative in S14, the first serial communication line 9a is selected in S15. If the determination is negative in S14, the serial communication lines 313 and 322 to which the corresponding ECU of the control system network 3 is connected are selected in S16.

Next, in S17, the data frame is input to the corresponding communication line such that the data frame is transmitted through the communication line selected in S13, S15, and S16 by the processing in the transmission unit 63.

The present embodiment can achieve advantages and effects such as the following:

(1) The in-vehicle network 100 is provided with the plurality of control system ECUs performing control related to the information on the vehicle 1 such as the meter control ECU 411, the plurality of control system ECUs controlling the power train of the vehicle 1 such as the engine control ECU 311, the integrated management gateway 7 communicably connected to the information system ECUs such as the meter control ECU 411 and having the input unit 70 to which the data signal from the diagnostic device 8 diagnosing the state of the vehicle 1 is input, the function integration module 6 communicably connected to the control system ECUs such as the engine control ECU 311, the first serial communication line 9a communicably connecting the integrated management gateway 7 and the function integration module 6, and the second serial communication line 9b disposed in parallel to the first serial communication line 9a and communicably connecting the integrated management gateway 7 and the function integration module 6 (FIG. 1). The data frame of the data signal input to the integrated management gateway 7 includes an ID (FIG. 2). When a data frame including an ID set to be communicated via the second serial communication line 9b is input to the integrated management gateway 7, the integrated management gateway 7 controls the flow of data such that the input data frame is transmitted via the second serial communication line 9b.

With this configuration, even when the ignition switch of the vehicle 1 is turned on during the failure diagnosis of the vehicle 1 using the ECUs of the control system network 3, the ECUs of the control system network 3 used for the diagnosis of the vehicle 1 and the diagnostic device 8 communicate with each other via the second serial communication line 9b. This can prevent occurrence of a communication delay or the like. As a result, the communication delay can be minimized, and it is therefore possible to prevent the device or the like from being erroneously determined as a failure on the basis of the communication delay.

(2) The data signal input to the function integration module 6 includes identification information (FIG. 2). When a data frame including an ID set to be communicated via the second serial communication line 9b is input to the function integration module 6, the function integration module 6 controls the flow of data such that the input data frame is transmitted via the second serial communication line 9b (FIG. 1). Thus, even when the ignition switch of the vehicle 1 is turned on during the failure diagnosis of the vehicle 1 using the ECUs of the control system network 3, the ECUs of the control system network 3 used for the diagnosis of the vehicle 1 and the diagnostic device 8 communicate with each other via the second serial communication line 9b. This can minimize a communication delay or the like. As a result, it is possible to prevent the device or the like from being erroneously determined as a failure on the basis of the communication delay.

(3) The input unit 70 of the integrated management gateway 7 is configured such that the first diagnostic signal having, as the transmission destination, the information system ECU performing the control related to the information on the vehicle 1 such as the meter control ECU 411 and the second diagnostic signal having, as the transmission destination, the control system ECU performing the control related to the power train of the vehicle 1 such as the engine control ECU 311 are input to the input unit 70 (FIG. 1). When the data frame including the first diagnostic signal is input to the integrated management gateway 7, the integrated management gateway 7 controls the flow of data such that the input data frame is transmitted to the meter control ECU 411 or the like. When the data frame including the second diagnostic signal is input to the integrated management gateway 7, the integrated management gateway 7 controls the flow of data such that the inputted data frame is transmitted to the engine control ECU 311 or the like via the second serial communication line 9b. This makes it possible to diagnose the vehicle 1 using the information system ECU performing the control related to the information on the vehicle 1 such as the meter control ECU 411 and the control system ECU performing the control related to the power train of the vehicle 1 such as the engine control ECU 311.

(4) The plurality of control system ECUs performing the control related to the power train of the vehicle 1 is provided. The plurality of control system ECUs includes the engine control ECU 311 controlling the engine 2 of the vehicle 1 (FIG. 1). It is therefore possible to prevent the failure of the device from being erroneously determined even when responsiveness is required, for example, when the failure of the emission-related device of the vehicle 1 is diagnosed.

In the above embodiment, the power train system network 31 and the chassis system network 32 are described as the control system network 3, but these are only examples, and the control system network 3 is not limited thereto. Similarly, the meter control ECU 411, the air conditioner control ECU 412, and the navigation control ECU 413 are described as the information system network 4, but these are only examples, and the information system network 4 is not limited thereto.

In the above embodiment, only the engine control ECU 311 and the transmission control ECU 312 are described as ECUs configuring the power train system network 31. However, the ECUs 311 and 312 are examples, and the ECUs configuring the power train system network 31 are not limited to the ECUs 311 and 312. Similarly, as the ECU configuring the chassis system network 32, only the steering control ECU 321 is described, but this is only an example. The ECU configuring the chassis system network 32 is not limited to the steering control ECU 321.

In the above embodiment, the plurality of information system ECUs is used as the first control units, but a single first control unit may be used. Similarly, although the plurality of control system ECUs is used as the second control units, a single second control unit may be used.

The above embodiment can be combined as desired with one or more of the above modifications. The modifications can also be combined with one another.

The present invention can prevent occurrence of a communication delay or the like even when the data signals are transmitted and received to and from the diagnostic device.

Above, while the present invention has been described with reference to the preferred embodiments thereof, it will be understood, by those skilled in the art, that various changes and modifications may be made thereto without departing from the scope of the appended claims.

What is claimed is:

1. A communication control system, comprising:
a first control unit configured to control a vehicle;
a second control unit configured to control the vehicle;
a first relay unit communicatively connected to the first control unit and having an input unit to which a data signal from a diagnostic unit diagnosing state of the vehicle is input;
a second relay unit communicatively connected to the second control unit;
a first communication line communicatively connecting the first relay unit and the second relay unit; and
a second communication line disposed in parallel to the first communication line and communicatively connecting the first relay unit and the second relay unit, wherein
the data signal input to the first relay unit includes identification information, wherein
the first relay unit controls flow of data so that the data signal input to the first relay unit is transmitted through the second communication line when the data signal input to the first relay unit includes the identification information set to be communicated through the second communication line.

2. The communication control system according to claim 1, wherein
the data signal input to the second relay unit includes the identification information, wherein
the second relay unit controls flow of data so that the data signal input to the second relay unit is transmitted through the second communication line when the data signal input to the second relay unit includes the identification information set to be communicated through the second communication line.

3. The communication control system according to claim 1, wherein
a first diagnostic signal to be transmitted to the first control unit and a second diagnostic signal to be transmitted to the second control unit are input to the input unit of the first relay unit, wherein
the first relay unit controls flow of data so that the first diagnostic signal input to the first relay unit is transmitted to the first control unit when the first diagnostic signal is input to the first relay unit, and controls flow of data so that the second diagnostic signal input to the first relay unit is transmitted to the second control unit through the second communication line when the second diagnostic signal is input to the first relay unit.

4. The communication control system according to claim 1, comprising:
a plurality of the second control unit, wherein
the plurality of the second control unit includes an engine control unit configured to control an engine of the vehicle.

5. The communication control system according to claim 1, wherein
the first relay unit and the second relay unit control flow of data so that the data signal transmitted between the first control unit and the second control unit is transmitted through the first communication line, and the data signal transmitted between the diagnostic unit and the second control unit is transmitted through the second communication line.
